(19) United States
(12) Patent Application Publication
(10) Pub. No.: US 2021/0270379 A1
(43) Pub. Date: Sep. 2, 2021

(54) FLUID SYSTEM

(71) Applicant: WIDEX A/S, Lynge (DK)

(72) Inventors: Michael Frydendal LARSSEN, Veksoe (DK); Per Kokholm SORENSEN, Virum (DK); Thorvaldur Oli BODVARSSON, Copenhagen S (DK); Boris VALNERT, Copenhagen V (DK)

(73) Assignee: WIDEX A/S, Lynge (DK)

(21) Appl. No.: 17/257,462

(22) PCT Filed: Jul. 4, 2019
(86) PCT No.: PCT/EP2019/067978

§ 371 Date: Dec. 31, 2020

Related U.S. Application Data
(60) Provisional application No. 62/694,650, filed on Jul. 6, 2018.

(30) Foreign Application Priority Data
Jul. 4, 2018 (DK) PA 2018 00326

(51) Int. Cl. F16K 15/14; F16K 99/00

(52) U.S. Cl. CPC F16K 15/147; H01M 8/04201; F16K 99/0057; F16K 99/0015

(57) ABSTRACT

Disclosed is a fluid system comprising a first member and a membrane sheet. The first member having a first surface, a first fluid inlet and a first flow channel. The membrane sheet having a first side, a second side opposite to the first side and a first slit, wherein the first side of the membrane sheet is abutting the first surface of the first member, the first flow channel forming a fluid passage from the first fluid inlet towards the first slit. The fluid system is configured to allow said membrane sheet to deform and thereby open said first slit and enable a fluid in the first flow channel to flow through the first slit when the pressure at the first slit is higher on the first side of the membrane sheet than on the second side of the membrane sheet.

### FIELD

The present invention relates to a fluid system.

### BACKGROUND

Fluid systems comprising one or more one-way valves are an important part of many products. It is desirable that the fluid systems are simple to manufacture and have a relatively small size.

This is however especially challenging to achieve for fluid systems handling small amount of fluids. An example of such a fluid system is a fluid system used in a docking station for refuelling a direct methanol fuel cell connected to a hearing aid where the fuel cell may be provided with less than 200 micro litres (0.2 ml) methanol in each refuelling operation.

EP0388828 discloses a unidirectional valve for fluids, particularly suited to be installed on containers. The valve includes a valve-body substantially in the shape of a cylindrical cap, preferably made of plastic material and provided with holes on the bottom and with a flexible plastic disk with a central hole.

It remains however a problem to provide an improved fluid system.

### SUMMARY

According to a first aspect, the invention relates to a fluid system comprising a first member and a membrane sheet, said first member having a first surface, a first fluid inlet and a first flow channel, said membrane sheet having a first side, a second side opposite to said first side and a first slit, wherein said first side of said membrane sheet is abutting said first surface of said first member, said first flow channel forming a fluid passage from said first fluid inlet towards said first slit,
wherein said fluid system is configured to allow said membrane sheet to deform and thereby open said first slit and enable a fluid in said first flow channel to flow through said first slit when the pressure at said first slit is higher on the first side of the membrane sheet than on the second side of the membrane sheet; and
wherein said fluid system is further configured to secure that said first slit is substantially closed when the pressure at said first slit is higher on the second side of the membrane sheet than on the first side of the membrane sheet.

Consequently, by using a membrane sheet to control the fluid to only flow from in one direction a simple and compact fluid system is provided.

The membrane sheet may be made of a resilient material, i.e. a material that returns to its the original form after being bent, compressed, or stretched. The membrane sheet may be made of materials such as silicone/elastomer. The first flow channel may be an open flow channel and/or a closed flow channel e.g. a first part of the first flow channel may be open and a second part of the first flow channel may be closed. The membrane sheet may function as a lid and close open parts of the first flow channel so that tube flow exists in substantially all of the first flow channel. The first fluid inlet may have a widest width below 10 cm, below 5 cm, below 2 cm, below 1 cm or below 0.5 cm. The first member may be made of a plastic material. The first member may be substantially flat. The first slit may be arranged with a distance to the first flow channel e.g. a distance between 0.5 mm and 10 mm, whereby the first slit will be pressed against the first surface of the first member and thereby kept substantially closed when the pressure at the first slit is higher on the second side of the membrane sheet than on the first side of the membrane sheet.

Another member may be arranged around said first slit at said second side of said membrane sheet e.g. a tube or a flat member. The fluid system may be configured to conduct any fluid such as a gas or a liquid e.g. water or methanol.

In some embodiments, said first slit in a relaxed state abuts said first surface of said first member along at least 50%, 70%, 90% or 100% of its length.

Consequently, the slit may more effectively be closed when the pressure at said first slit is higher on the second side of the membrane sheet than on the first side of the membrane sheet.

In some embodiments, said fluid system further comprises a second member having a first surface, a second flow channel and a first fluid outlet, wherein said second side of said membrane sheet is abutting said first surface of said second member and said second flow channel is forming a fluid passage from said first slit to said first fluid outlet whereby said first fluid inlet of said first member is fluidly connected to said first fluid outlet of said second member via said first slit of said membrane sheet when the pressure at said first slit is higher on the first side of the membrane sheet than on the second side of the membrane sheet.

Consequently, the membrane sheet may be kept in position in a simple manner.

The second flow channel may be an open flow channel and/or a closed flow channel e.g. a first part of the second flow channel may be closed and a second part of the second flow channel may be closed. The second fluid inlet may have a widest width below 10 cm, below 5 cm, below 2 cm, below 1 cm or below 0.5 cm. The second member may be made of a plastic material. The second member may be substantially flat. The first fluid outlet may have a widest width below 10 cm, below 5 cm, below 2 cm, below 1 cm or below 0.5 cm.

In some embodiments, said second member has a first cavity portion forming part of said second flow channel, said first slit being arranged at said first cavity portion of said second member allowing said membrane sheet to deform into said first cavity portion and thereby open said first slit when the pressure at said first slit is higher on the first side of the membrane sheet than on the second side of the membrane sheet.

The first cavity portion may be configured to accommodate the deformed membrane sheet.

In some embodiments, the first member further has a second fluid inlet and a third flow channel, said membrane sheet further has a second slit, said third flow channel forming a fluid passage from said second fluid inlet towards said second slit,
wherein said fluid system is configured to allow said membrane sheet to deform and thereby open said second slit and enable a fluid in said third flow channel to flow through said second slit when the pressure at said second slit is higher on the first side of the membrane sheet than on the second side of the membrane sheet; and
wherein said fluid system is further configured to secure that said second slit is substantially closed when the pressure at said second slit is higher on the second side of the membrane sheet than on the first side of the membrane sheet.

The second fluid inlet may have a widest width below 10 cm, below 5 cm, below 2 cm, below 1 cm or below 0.5 cm. The third flow channel may an open flow channel and/or a closed flow channel. The second slit may be arranged with a distance to the third flow channel e.g. a distance between 0.5 mm and 10 mm, whereby the first slit will be pressed against the first surface of the first member and thereby kept substantially closed when the pressure at the first slit is higher on the second side of the membrane sheet than on the first side of the membrane sheet.

In some embodiments, said second member further has a fourth flow channel and a second fluid outlet, said fourth flow channel is forming a fluid passage from said second slit to said second fluid outlet whereby said second fluid inlet of said first member is fluidly connected to said second fluid outlet of said second member via said second slit of said membrane sheet when the pressure at said second slit is higher on the first side of the membrane sheet than on the second side of the membrane sheet.

The second fluid outlet may have a widest width below 10 cm, below 5 cm, below 2 cm, below 1 cm or below 0.5 cm. The fourth flow channel may be an open flow channel and/or a closed flow channel.

In some embodiments, said second member has a second cavity portion forming part of said fourth flow channel, said second slit being arranged at said second cavity portion of said second member allowing said membrane sheet to deform into said second cavity portion and thereby open said second slit when the pressure at said second slit is higher on the first side of the membrane sheet than on the second side of the membrane sheet.

In some embodiments, said first member further has a third fluid outlet and a fifth flow channel, said first fluid inlet and said third fluid outlet being combined into a first inlet/outlet fluid connection port, said membrane sheet having a third slit, said fifth flow channel forming a fluid passage from said first inlet/outlet fluid connection port to said third slit,
wherein said fluid system is configured to allow said membrane sheet to deform and thereby open said third slit and enable a fluid to flow through said third slit when the pressure at said third slit is higher on the second side of the membrane sheet than on the first side of the membrane sheet; and
wherein said fluid system is further configured to secure that said third slit is substantially closed when the pressure at said third slit is higher on the first side of the membrane sheet than on the second side of the membrane sheet.

The fifth flow channel may an open flow channel and/or a closed flow channel. The third slit may be arranged with a distance to the fifth flow channel e.g. a distance between 0.5 mm and 10 mm, whereby the third slit will be pressed against the first surface of the second member and thereby kept substantially closed when the pressure at the third slit is higher on the first side of the membrane sheet than on the second side of the membrane sheet.

In some embodiments, said first member has a third cavity portion forming part of said fifth flow channel, said third slit being arranged at said third cavity portion of said first member allowing said membrane sheet to deform into said third cavity portion and thereby open said third slit when the pressure at said third slit is higher on the second side of the membrane sheet than on the first side of the membrane sheet.

In some embodiments, said second member has a sixth flow channel and a third fluid inlet, said sixth flow channel is forming a fluid passage from said third fluid inlet toward said third slit whereby said first inlet/outlet fluid connection port of said first member is fluidly connected to said third fluid inlet of said second member via said third slit of said membrane sheet when the pressure at said third slit is higher on the second side of the membrane sheet than on the first side of the membrane sheet.

The sixth flow channel may an open flow channel and/or a closed flow channel. The third fluid inlet may have a widest width below 10 cm, below 5 cm, below 2 cm, below 1 cm or below 0.5 cm.

In some embodiments, said first member further have a fourth fluid outlet and a seventh flow channel, said second fluid inlet and said fourth fluid outlet being combined into a second inlet/outlet fluid connection port, said membrane sheet having a fourth slit, said seventh flow channel forming a fluid passage from said second inlet/outlet fluid connection port to said fourth slit,
wherein said fluid system is configured to allow said membrane sheet to deform and thereby open said fourth slit and enable a fluid in said seventh flow channel to flow through said fourth slit when the pressure at said fourth slit is higher on the second side of the membrane sheet than on the first side of the membrane sheet; and
wherein said fluid system is further configured to secure that said fourth slit is substantially closed when the pressure at said fourth slit is higher on the first side of the membrane sheet than on the second side of the membrane sheet.

The seventh flow channel may be an open flow channel and/or a closed flow channel. The fourth slit may be arranged with a distance to the seventh flow channel e.g. a distance between 0.5 mm and 10 mm, whereby the fourth slit will be pressed against the first surface of the second member and thereby kept substantially closed when the pressure at the fourth slit is higher on the first side of the membrane sheet than on the second side of the membrane sheet.

In some embodiments said first member has a fourth cavity portion forming part of said seventh flow channel, said fourth slit being arranged at said fourth cavity portion of said first member allowing said membrane sheet to deform into said fourth cavity portion and thereby open said fourth slit when the pressure at said fourth slit is higher on the second side of the membrane sheet than on the first side of the membrane sheet.

In some embodiments, said second member have an eighth flow channel and a fourth fluid inlet, said first fluid outlet and said fourth fluid inlet being combined into a third inlet/outlet fluid connection port, said eighth flow channel is forming a fluid passage from said third inlet/outlet fluid connection port toward said fourth slit whereby said second inlet/outlet fluid connection port of said first member is fluidly connected to said third inlet/outlet fluid connection port via said fourth slit of said membrane sheet when the pressure at said fourth slit is higher on the second side of the membrane sheet than on the first side of the membrane sheet.

The eighth flow channel may an open flow channel and/or a closed flow channel.

In some embodiments the first surface of the first member and/or the second member comprise(s) a curved, convex portion in an area of a cavity portion of the opposing member. The opposing member will be the second member if said first surface is of the first member. Likewise, the opposing member will be the first member if said first surface is of the second member.

In a preferred embodiment, the curved, convex portion of the first and/or second member has a circular shape seen from a top view of the first and second member.

The curved, convex portion of the first and/or second member causes the membrane sheet to be pre-stretched and extend into a cavity portion of the opposing member. This pre-stretching has the effect that the closing of the slit in the same area is increased. This pretension secures that the membrane sheet does not lift from the first surface of the first and or second member, thus preventing leakage, and gives a much more well-defined opening pressure. The opening pressure is defined as the pressure needed to open the slit, i.e. when the pressure at the slit is higher on one side of the membrane sheet than on the other side of the membrane sheet in the flow direction.

In a preferred embodiment, one or more slits of the membrane sheet is placed in a direction which is approximately coinciding with a radius of the curved, convex portion of the first surface of the first member and/or the second member. With this specific direction and placement of the slit(s), sealing is increased in that the slit(s) are stretched in a longitudinal direction of the slit(s), when the membrane sheet is stretched over the curved, convex portion(s) of the first surface(s) of the first and/or second member, thereby decreasing the risk of leakage.

The different aspects of the present invention can be implemented in different ways including fluid systems described above and in the following, each yielding one or more of the benefits and advantages described in connection with at least one of the aspects described above, and each having one or more preferred embodiments corresponding to the preferred embodiments described in connection with at least one of the aspects described above and/or disclosed in the dependent claims. Furthermore, it will be appreciated that embodiments described in connection with one of the aspects described herein may equally be applied to the other aspects.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

FIGS. 1a-f show a fluid system according to an embodiment of the present invention.

FIGS. 2a-b show a fluid system according to an embodiment of the present invention.

FIGS. 3a-c show a fluid system according to an embodiment of the present invention.

FIGS. 4a-b show a fluid system according to an embodiment of the present invention.

FIGS. 5a-e show a fluid system according to an embodiment of the present invention.

FIGS. 6a-b show a fluid system according to an embodiment of the present invention.

FIG. 7 shows a membrane sheet of a fluid system according to an embodiment of the present invention.

### DETAILED DESCRIPTION

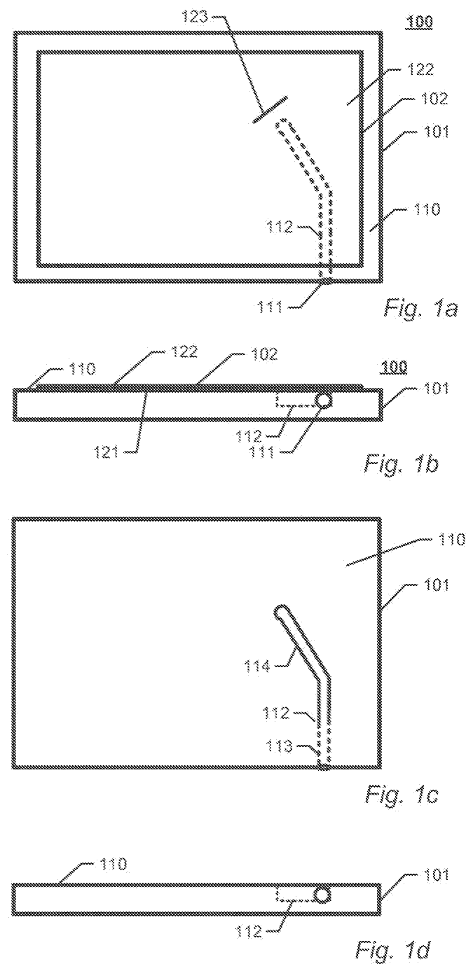

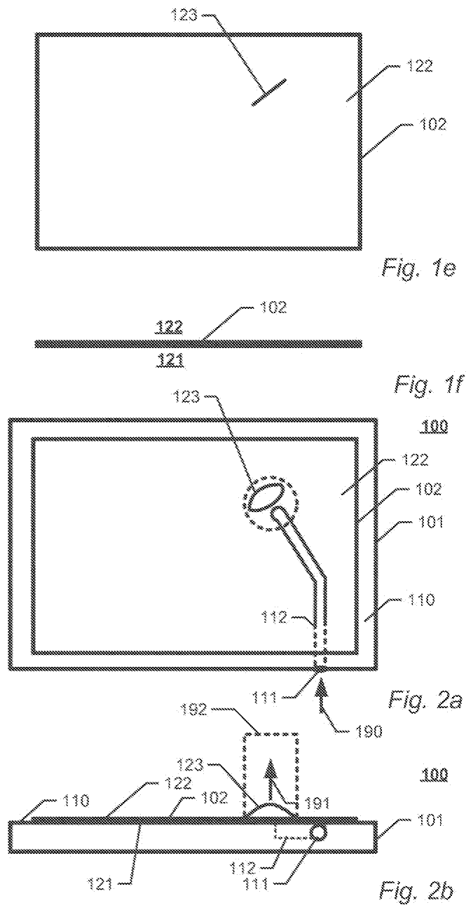

FIGS. 1a-f show a fluid system 100 according to an embodiment of the present invention. The fluid system 100 comprises a first member 101 and a membrane sheet 102. FIG. 1a shows a top view of the fluid system 100, FIG. 1b shows a side view of the fluid system 100, FIG. 1c shows a top view of the first member 101, FIG. 1d shows a side view of the first member 101, FIG. 1e shows a top view of the membrane sheet 102, and FIG. 1f shows a side view of the membrane sheet 102. Throughout this description dashed lines are used to illustrate hidden parts.

The first member 101 has a first surface 110, a first fluid inlet 111 and a first flow channel 112. The membrane sheet 102 has a first side 121, a second side 122 opposite to said first side 121 and a first slit 123. The first side of the membrane sheet 121 is abutting the first surface of the first member 110 and the membrane sheet 102 is made of a resilient material. The first flow channel 112 forms a fluid passage from the first fluid inlet 111 towards the first slit 123. In this embodiment the first slit 123 is arranged with a distance to the first flow channel 112. The fluid system 100 is configured to allow the membrane sheet 102 to deform and thereby open the first slit 123 and enable a fluid in the first flow channel 112 to flow through the first slit 123 when the pressure at the first slit 123 is higher on the first side of the membrane sheet 121 than on the second side of the membrane sheet 122. The fluid system 100 is further configured to secure that the first slit 123 is substantially closed when the pressure at the first slit 123 is higher on the second side of the membrane sheet 122 than on the first side of the membrane sheet 121. The first flow channel 112 has a first part 113 that is closed (formed internally in the first member 101) and a second part 114 that is open. The second part 114 will however be closed by the membrane sheet, whereby pipe flow will be present in both the first part 113 and the second part 114.

FIGS. 2a-b show the fluid system of FIG. 1 when the pressure at the first slit 123 is higher on the first side of the membrane sheet 121 than on the second side of the membrane sheet 122. This allows a fluid to enter 190 the first fluid inlet 111 and exit 191 through the first slit 123. Another member 192 may be arranged around the first slit 123 at said second side of the membrane sheet 122 e.g. a tube or flat member. The other member 192 may secure that only the part of the membrane sheet 102 in proximity of the first slit 123 is allowed to deform when the pressure at the first slit 123 is higher on the first side of the membrane sheet 121 than on the second side of the membrane sheet 122.

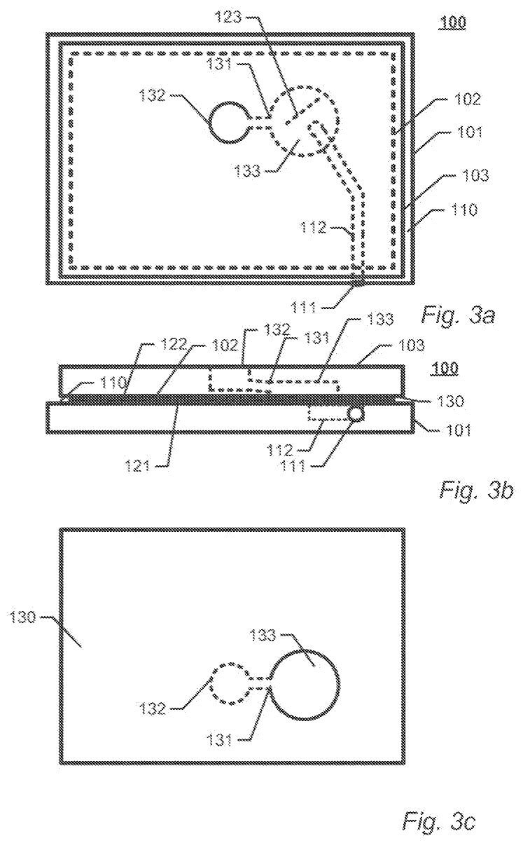

FIGS. 3a-c show a fluid system 100 according to an embodiment of the present invention. The fluid system 100 comprises a first member 101, a membrane sheet 102, and a second member 103. The first member 101 and the membrane sheet 102 are identical to the first member 101 and the membrane sheet 102 disclosed in relation to FIG. 1. FIG. 3a shows a top view of the fluid system 100, FIG. 3b shows a side view of the fluid system 100, and FIG. 3c shows a bottom view of the second member 103. The second member 103 has a first surface 130, a second flow channel 131 and a first fluid outlet 132. The second side 122 of the membrane sheet 102 is abutting the first surface 130 of said second member 103 and the second flow channel 131 is forming a fluid passage from the first slit 123 to the first fluid outlet 132 whereby the first fluid inlet 111 of the first member 101 is fluidly connected to the first fluid outlet 132 of the second member 103 via the first slit 123 of the membrane sheet 102 when the pressure at the first slit 123 is higher on the first side of the membrane sheet than on the second side of the membrane sheet 102. The second member 103 has a first cavity portion 133 forming part of the second flow channel 131, the first slit 123 being arranged at the first cavity portion 133 of the second member 103 allowing the membrane sheet 102 to deform into the first cavity portion 133 and thereby open the first slit 123 when the pressure at the first slit 123 is higher on the first side 121 of the membrane sheet 102 than on the second side 122 of the membrane sheet 102.

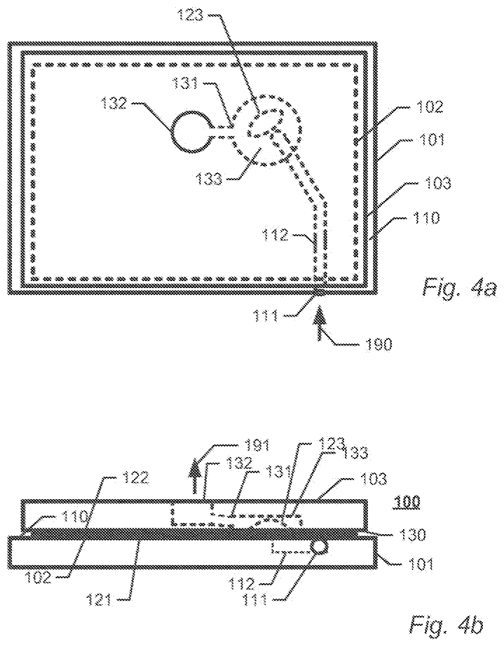

FIGS. 4a-b show the fluid system of FIG. 3 when the pressure at the first slit 123 is higher on the first side 121 of the membrane sheet 102 than on the second side 122 of the membrane sheet 102. This allows a fluid to enter 190 the first fluid inlet 111 and exit 191 through the first fluid outlet 132.

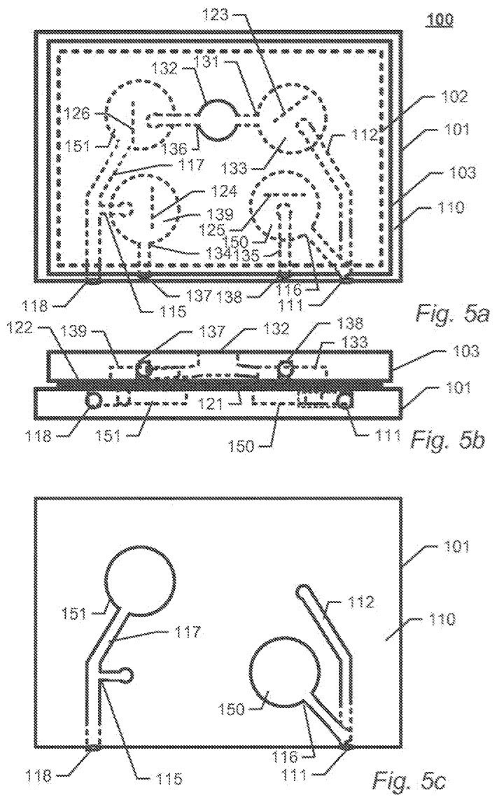

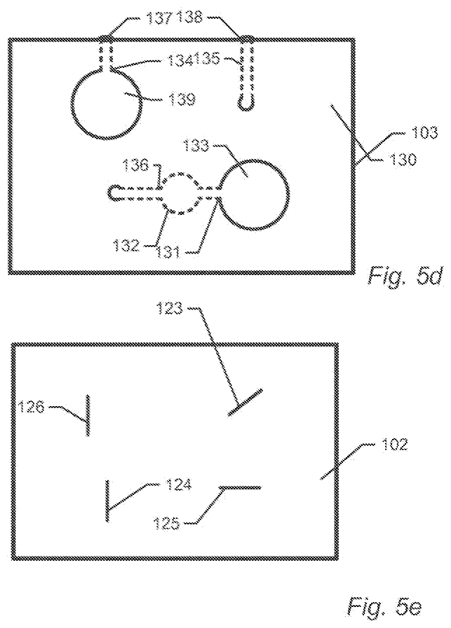

FIGS. 5a-e show a fluid system 100 according to an embodiment of the present invention. The fluid system 100 comprises a first member 101, a membrane sheet 102, and a second member 103. FIG. 5a shows a top view of the fluid system 100, FIG. 5b shows a side view of the fluid system 100, FIG. 5c shows a top view of the first member 101, FIG. 5d shows a bottom view of the second member 103, and FIG. 5e shows a top view of the membrane sheet 102. The first member 101 has a first surface 110, a first inlet/outlet fluid connection port 111, a second inlet/outlet fluid connection port 118, a first flow channel 112, a third flow channel 115, a fifth flow channel 116 and a seventh flow channel 117. The membrane sheet 102 has a first side 121, a second side 122 opposite to said first side 121, a first slit 123, a second slit 124, a third slit 125, and a fourth slit 126. The second member 103 has a first surface 130, a third inlet/outlet fluid connection port 132, a second fluid outlet 137, a third fluid inlet 138, a second flow channel 131, a fourth flow channel 134, a sixth flow channel 135, and an eighth flow channel 136. The first side 121 of the membrane sheet 102 is abutting the first surface 110 of the first member 101 and the second side 122 of the membrane sheet 102 is abutting the first surface 130 of the second member 103. The first flow channel 112 forms a fluid passage from the first inlet/outlet fluid connection port 111 towards the first slit 123, the second flow channel 131 forms a fluid passage from the first slit 123 to the third inlet/outlet fluid connection port 132, the third flow channel 115 forms a fluid passage from the second inlet/outlet fluid connection port 118 towards the second slit 124, the fourth flow channel 134 forms a fluid passage from the second slit 124 to the second fluid outlet 137, the fifth flow channel 116 forms a fluid passage from the third slit 125 to the first inlet/outlet fluid connection port 111, the sixth flow channel 135 forms a fluid passage from the third fluid inlet 138 towards the third slit 125, the seventh flow channel 117 forms a fluid passage from the fourth slit 126 to the second inlet/outlet fluid connection port 118, and the eighth flow channel 136 forms a fluid passage from the third inlet/outlet fluid connection port 132 towards the fourth slit 126. The second member 103 has a first cavity portion 133 forming part of the second flow channel 131, and a second cavity portion 139 forming part of the fourth flow channel 134. The first member 101 has a third cavity portion 150 forming part of the fifth flow channel 116, and a fourth cavity portion 151 forming part of the seventh flow channel 117.

The fluid system 100 is configured to allow the membrane sheet 102 to deform into the first cavity portion 133 and thereby open the first slit 123 and enable a fluid to flow from the first inlet/outlet fluid connection port 111 to the third inlet/outlet fluid connection port 132 via the first slit 123 when the pressure at the first slit 123 is higher on the first side of the membrane sheet 121 than on the second side of the membrane sheet 122; and wherein the fluid system 100 is further configured to secure that the first slit 123 is substantially closed when the pressure at the first slit 123 is higher on the second side of the membrane sheet 122 than on the first side of the membrane sheet 121.

The fluid system 100 is further configured to allow the membrane sheet 102 to deform into the second cavity portion 139 and thereby open the second slit 124 and enable a fluid to flow from the second inlet/outlet fluid connection port 118 to the second fluid outlet 137 via the second slit 124 when the pressure at the second slit 124 is higher on the first side 121 of the membrane sheet 102 than on the second side 122 of the membrane sheet 102; and wherein the fluid system 100 is further configured to secure that the second slit 124 is substantially closed when the pressure at the second slit 124 is higher on the second side 122 of the membrane sheet 102 than on the first side 121 of the membrane sheet 102.

The fluid system 100 is further configured to allow the membrane sheet 102 to deform into the third cavity portion 150 and thereby open the third slit 125 and enable a fluid to flow from the third fluid inlet 138 to the first inlet/outlet fluid connection port 111 via the third slit 125 when the pressure at the third slit 125 is higher on the second side 122 of the membrane sheet 102 than on the first side 121 of the membrane sheet 102; and wherein the fluid system 100 is further configured to secure that the third slit 125 is substantially closed when the pressure at the third slit 125 is higher on the first side 121 of the membrane sheet 102 than on the second side 122 of the membrane sheet 102.

The fluid system 100 is further configured to allow the membrane sheet 102 to deform into the fourth cavity portion 151 and thereby open the fourth slit 126 and enable a fluid to flow from the third inlet/outlet fluid connection port 132 to the second inlet/outlet fluid connection port 118 via the fourth slit 126 when the pressure at the fourth slit 126 is higher on the second side 122 of the membrane sheet 102 than on the first side 121 of the membrane sheet 102; and wherein the fluid system 100 is further configured to secure that the fourth slit 126 is substantially closed when the pressure at the fourth slit 126 is higher on the first side 121 of the membrane sheet 102 than on the second side 122 of the membrane sheet 102.

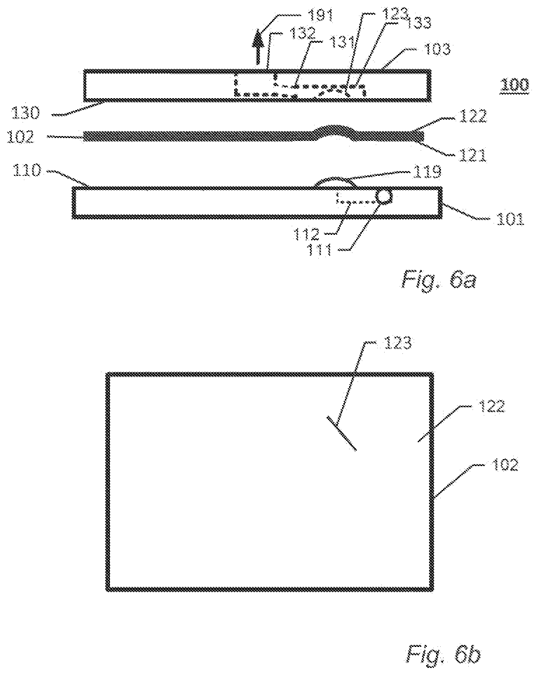

FIG. 6a shows an exploded view of a fluid system according to an embodiment of the present invention. The fluid system 100 comprises a first member 101, a membrane sheet 102, and a second member 103. FIG. 6a shows an exploded side view of the fluid system 100. The second member 103 has a first surface 130, a second flow channel 131 and a first fluid outlet 132. Although it is an exploded view, it is to be understood that in an assembled system, the second side 122 of the membrane sheet 102 is abutting the first surface 130 of said second member 103 and the second flow channel 131 is forming a fluid passage from the first slit 123 to the first fluid outlet 132 whereby the first fluid inlet 111 of the first member 101 is fluidly connected to the first fluid outlet 132 of the second member 103 via the first slit 123 of the membrane sheet 102 when the pressure at the first slit 123 is higher on the first side of the membrane sheet than on the second side of the membrane sheet 102. The second member 103 has a first cavity portion 133 forming part of the second flow channel 131, the first slit 123 being arranged at the first cavity portion 133 of the second member 103. In this embodiment, the first surface 110 of the first member 101 comprises a curved, convex portion 119 in the area of the first cavity portion 133 of the second member 103. As a result, the membrane sheet 102 is stretched and deformed into the first cavity portion 133. When the pressure at the first slit 123 is higher on the first side 121 of the membrane sheet 102 than on the second side 122 of the membrane sheet 102, the first slit 123 will open.

FIG. 6b shows a preferred embodiment of the membrane sheet 102 where the direction of the first slit 123 is approximately coinciding with a radius of the curved, convex portion 119 of the first surface 110 of the first member 101 (not shown).

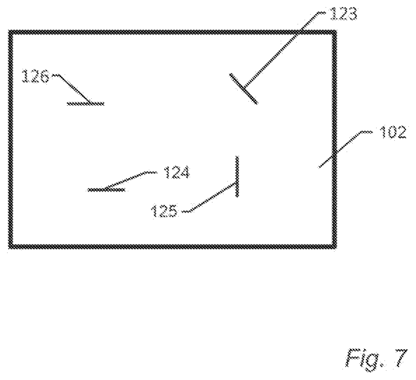

FIG. 7 shows a membrane sheet 102 of a fluid system according to the present invention, the membrane sheet 102 comprising a first slit 123, a second slit 124, a third slit 125 and a fourth slit 126 according to a preferred embodiment of the invention. The direction of the first slit 123 is approximately coinciding with a radius of the curved, convex portion 119 of the first surface 110 of the first member 101 (not shown). The directions of the second slit 124, the third slit 125, and the fourth slit 126 are similarly aligned with the radii of the curved, convex portions of the first member 101 and the second member 103, respectively (not shown).

In the illustrated embodiments, the first member 101 and the second member 103 have different size, i.e. the first member 101 is larger than the second member 103. However, in other embodiments, the second member 103 may be equal to or larger than the first member 101.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A fluid system comprising a first member and a membrane sheet, said first member having a first surface, a first fluid inlet and a first flow channel, said membrane sheet having a first side, a second side opposite to said first side and a first slit, wherein said first side of said membrane sheet is abutting said first surface of said first member, said first flow channel forming a fluid passage from said first fluid inlet towards said first slit,
wherein said fluid system is configured to allow said membrane sheet to deform and thereby open said first slit and enable a fluid in said first flow channel to flow through said first slit when the pressure at said first slit is higher on the first side of the membrane sheet than on the second side of the membrane sheet; and
wherein said fluid system is further configured to secure that said first slit is substantially closed when the pressure at said first slit is higher on the second side of the membrane sheet than on the first side of the membrane sheet.

2. A fluid system according to claim 1, wherein said first slit in a relaxed state abuts said first surface of said first member along at least 50%, 70%, 90% or 100% of its length.

3. A fluid system according to claim 1, wherein said fluid system further comprises a second member having a first surface, a second flow channel and a first fluid outlet, wherein said second side of said membrane sheet is abutting said first surface of said second member and said second flow channel is forming a fluid passage from said first slit to said first fluid outlet whereby said first fluid inlet of said first member is fluidly connected to said first fluid outlet of said second member via said first slit of said membrane sheet when the pressure at said first slit is higher on the first side of the membrane sheet than on the second side of the membrane sheet.

4. A fluid system according to claim 3, wherein said second member has a first cavity portion forming part of said second flow channel, said first slit being arranged at said first cavity portion of said second member allowing said membrane sheet to deform into said first cavity portion and thereby open said first slit when the pressure at said first slit is higher on the first side of the membrane sheet than on the second side of the membrane sheet.

5. A fluid system according to claim 1, wherein the first member further has a second fluid inlet and a third flow channel, said membrane sheet further has a second slit, said third flow channel forming a fluid passage from said second fluid inlet towards said second slit,
wherein said fluid system is configured to allow said membrane sheet to deform and thereby open said second slit and enable a fluid in said third flow channel to flow through said second slit when the pressure at said second slit is higher on the first side of the membrane sheet than on the second side of the membrane sheet; and
wherein said fluid system is further configured to secure that said second slit is substantially closed when the pressure at said second slit is higher on the second side of the membrane sheet than on the first side of the membrane sheet.

6. A fluid system according to claim 3, wherein said second member further has a fourth flow channel and a second fluid outlet, said fourth flow channel is forming a fluid passage from said second slit to said second fluid outlet whereby said second fluid inlet of said first member is fluidly connected to said second fluid outlet of said second member via said second slit of said membrane sheet when the pressure at said second slit is higher on the first side of the membrane sheet than on the second side of the membrane sheet.

7. A fluid system according to claim 6, wherein said second member has a second cavity portion forming part of said fourth flow channel, said second slit being arranged at said second cavity portion of said second member allowing said membrane sheet to deform into said second cavity portion and thereby open said second slit when the pressure at said second slit is higher on the first side of the membrane sheet than on the second side of the membrane sheet.

8. A fluid system according to claim 1, wherein said first member further has a third fluid outlet and a fifth flow channel, said first fluid inlet and said third fluid outlet being combined into a first inlet/outlet fluid connection port, said membrane sheet having a third slit, said fifth flow channel forming a fluid passage from said first inlet/outlet fluid connection port to said third slit,
wherein said fluid system is configured to allow said membrane sheet to deform and thereby open said third slit and enable a fluid to flow through said third slit when the pressure at said third slit is higher on the second side of the membrane sheet than on the first side of the membrane sheet; and
wherein said fluid system is further configured to secure that said third slit is substantially closed when the pressure at said third slit is higher on the first side of the membrane sheet than on the second side of the membrane sheet.

9. A fluid system according to claim 8, wherein said first member has a third cavity portion forming part of said fifth flow channel, said third slit being arranged at said third cavity portion of said first member allowing said membrane sheet to deform into said third cavity portion and thereby open said third slit when the pressure at said third slit is higher on the second side of the membrane sheet than on the first side of the membrane sheet.

10. A fluid system according to claim 3, wherein said second member has a sixth flow channel and a third fluid inlet, said sixth flow channel is forming a fluid passage from said third fluid inlet toward said third slit whereby said first inlet/outlet fluid connection port of said first member is fluidly connected to said third fluid inlet of said second member via said third slit of said membrane sheet when the pressure at said third slit is higher on the second side of the membrane sheet than on the first side of the membrane sheet.

11. A fluid system according to claim 8, wherein said first member further has a fourth fluid outlet and a seventh flow channel, said second fluid inlet and said fourth fluid outlet being combined into a second inlet/outlet fluid connection port, said membrane sheet having a fourth slit, said seventh flow channel forming a fluid passage from said second inlet/outlet fluid connection port to said fourth slit,
wherein said fluid system is configured to allow said membrane sheet to deform and thereby open said fourth slit and enable a fluid in said seventh flow channel to flow through said fourth slit when the pressure at said fourth slit is higher on the second side of the membrane sheet than on the first side of the membrane sheet; and
wherein said fluid system is further configured to secure that said fourth slit is substantially closed when the pressure at said fourth slit is higher on the first side of the membrane sheet than on the second side of the membrane sheet.

12. A fluid system according to claim 11, wherein said first member has a fourth cavity portion forming part of said seventh flow channel, said fourth slit being arranged at said fourth cavity portion of said first member allowing said membrane sheet to deform into said fourth cavity portion and thereby open said fourth slit when the pressure at said fourth slit is higher on the second side of the membrane sheet than on the first side of the membrane sheet.

13. A fluid system according to claim 3, wherein said second member has an eighth flow channel and a fourth fluid inlet, said first fluid outlet and said fourth fluid inlet being combined into a third inlet/outlet fluid connection port, said eighth flow channel is forming a fluid passage from said third inlet/outlet fluid connection port toward said fourth slit whereby said second inlet/outlet fluid connection port of said first member is fluidly connected to said third inlet/outlet fluid connection port via said fourth slit of said membrane sheet when the pressure at said fourth slit is higher on the second side of the membrane sheet than on the first side of the membrane sheet.

14. A fluid system according to claim 3, wherein the first surface of the first member and/or the second member comprise(s) a curved, convex portion in an area of a cavity portion of the opposing member.

15. A fluid system according to claim 14, wherein a slit of the membrane sheet is placed in a direction which is approximately coinciding with a radius of the curved, convex portion of the first surface of the first member and/or the second member.
